(19) United States
(12) Patent Application Publication
(10) Pub. No.: US 2024/0242057 A1
(43) Pub. Date: Jul. 18, 2024

(54) Jewelry for example a necklace, pendant, broach, or ring with embedded or attached NFC or RFID Or any other item organic or inorganic to which a digital tag can be embedded or attached

(71) Applicant: Simon Naparstek, New York, NY (US)

(72) Inventor: Simon Naparstek, New York, NY (US)

(21) Appl. No.: 18/097,050

(22) Filed: Jan. 13, 2023

(51) Int. Cl. G06K 19/077; G06K 19/06

(52) U.S. Cl. CPC G06K 19/07762; G06K 19/06037

(57) ABSTRACT

A method relates to a kind of novel approach to storing, organizing, retrieving, and sharing information saved in terms of text, photos, videos, audio files, documents, and links at the centralized database. This intelligent platform allows users to save information through the interface and a unique QR code/RFID/NFC tag is generated which can be printed, embossed or engraved or attached on any item of use including but not limited to jewelry, toys, clothing, flowers, fruits, gift cards, chocolates and so on. This platform allows to saving of information for the deceased or can be used to celebrate occasions with living people in form of a tiny tag. It could be coated in gold or silver or any appropriate material such as gold, silver, or lucite and discretely attached or embedded on the gift item.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention relates to the field of social life, and more specifically, to a digital platform in form of a website coupled with a QR code/NFC/RFID engraved on or embedded within or attached to a tag that can be coated with precious/non-precious material to passed as a gift, whereby using the code a user can store, organize, search and retrieve life data of individuals and pets stored in form of pictures, videos, documents, soundtracks, recordings, and links. The attached tag can also display the message in form of pictures, text, audio, and videos for loved ones on any occasion like birthdays, anniversaries, new year, Christmas and so on.

### Description of the Related Art

Items of jewelry are often given as gifts to signify important moments in life such as a wedding or engagement, birthdays, or other celebrations. Items of jewelry include rings, pendants, bracelets, beads, brooches, and the like. Often the gift giver opts to engrave the item to impart a special personal message for the recipient: “I love you” or perhaps even “For you, on our wedding day 12 Aug. 2006” or “Congratulations on passing your exams”. Typically, wedding, engagement, and eternity rings are engraved on the inner surface of the ring in a symbolic gesture of intimacy; and only the giver and receiver need to know the message is there and what the message is.

Celebration jewelry, given to a recipient to mark an important life event, may include a bracelet or necklace with charms, beads, or pendants, and these items may also be engraved with a message or date adding that personal intimate touch.

Engraving items or pieces of jewelry may require some skill, time, and effort and often requires some sort of machinery or engraving tool. It can be difficult to engrave very small pieces of jewelry and especially challenging to engrave pieces of jewelry with patterned or contoured surfaces. Furthermore, there is a limited space in which a person may engrave a message on any piece of jewelry and the character size is limited so the resultant content of the message is also limited. For example, the message on the inside of a wedding band is typically restricted to only a few characters, for example, 25 characters. Clearly, any such message is thus very limited.

Radio-frequency identification (RFID) uses radio-frequency electromagnetic fields to transfer data from a tag or chip attached to an object, principally for the purposes of automatic identification (e.g., allowing a person access to a building) and tracking and monitoring products (such as stocktaking or assembly line monitoring). Some tags or chips are passive and do not require a battery. Passive tags or chips are powered by the electromagnetic fields used to read them. Non passive tags or chips use a local power source and emit radio waves (electromagnetic radiation at radio frequencies). The tag or chip contains electronically stored information which can be read by a reader from up to several meters away. Near field communication (NFC) is a set of standards covering communications protocols based on existing RFID. NFC requires touch or bringing a reader and tag into close proximity to each other in order to establish radio communication with each other.

The prior art shows a variety of uses of RFID tags and chips. International patent application WO 2011/154213A provides a system for monitoring the stock in dynamic stores using RFID and discloses an RFID communication system, comprising at least a first stationary RFID antenna and a second stationary RFID antenna for transmitting and receiving data; and an RFID transponder fitted to an item or a group of items, wherein the RFID transponder electronically stores at least one identifier of the item or the group of items, and wherein the first RFID antenna is placed at an intake region and the second RFID antenna is placed at an issue region of a storage path of the dynamic store in order to detect the item or the group of items using the identifier of the RFID transponder.

Taiwanese patent application TW 2009/19344A discloses the use of RFID tags in ticket applications. An anti-counterfeiting electronic ticket system is disclosed, which is used as an anti-counterfeiting application to prevent a simple electronic ticket from misuse of an illegal duplication means by means of a photographing method. A certificate can be an image, a pattern or words, and is printed on a sticker or on the surface of other entity articles by means of an anti-counterfeiting printing technology. Alternatively, the certificate can be a wireless radio frequency identification (RFID) label to form an entity certificate. A user holds an electronic ticket image displayed on a monitor of a mobile apparatus and a pre-registered entity certificate, utilizes a ticket-examining apparatus to read content information of the entity certificate and the electronic ticket, and verifies by mutual certification method of the two to be used as imitation prevention of the electronic ticket.

There are multiple solutions that have been presented in prior art regarding the effective utilization of digital technology for users in daily life. However, these solutions are limited and restricted to their conventional systems and are uniform in their nature. The current invention is focused on presenting a method for providing a digital interface in terms of an application where people can store personal information including but not limited to text, Pictures, Videos, Documents, Sound Tracks, voice recordings, and links.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved method for securely designed applications that is based on the storage and retrieval of personal information in form of a QR code/NFC/RFID printed on any item of use including but not limited to clothing, toys, jewelry, flowers, fruit, chocolate candies and so on.

It is also the primary objective of the invention to provide a smart methodology directed to devices, systems, and methods for facilitating and allowing the user to easily organize, store, retrieve and display images, audio, videos, and links as per the pre-set requirements.

It is another objective of the invention to provide a system providing advanced system, typically by using smart devices, for instance, mobile phones, tablets, iPad or laptops.

It is also the object of the invention to provide an advanced system where users can scan the code to read the life story created by a particular user for an individual or pet.

It is further the objective of the invention to provide an advanced system that allows the sharing of personalized messages in form of text, pictures, audio, and videos with other users on their special occasions.

This Summary is provided merely for purpose of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to an advanced assembly which is a special type of software aiming at creating a complete life history of an individual or an animal in searchable, organizable data of photos and is easily accessible through a unique QR code/NFC/RFID

The system as per its preferred embodiments is a one-of-a-kind system that blends to help the world see and hear the personal life history in few clicks.

In preferred embodiments of the invention, the reader is provided with NFC/RFID/QR code and a smart device adapted to decode the machine-readable symbol into the first set of information, a transmitter adapted to send the first query to the data repository by way of a communication network. The first query is preferably based on the first set of information, and the device receiver is adapted to receive a second set of information from the data repository by way of the communication network. The device is further provided with a display adapted to present the first set of information related to particular NFC/QR code/RFID.

To explain the process further the reader uses the portable device that incorporates a code reading apparatus to read the machine-readable symbol. A suitable device for reading the symbol includes for example an iPhone® device manufactured by Apple, Inc., Cupertino, Calif., U.S.A. U.S. Pat. No. 5,691,527 to Hara, et al., the disclosure of which is incorporated herein by reference also discloses a suitable two-dimensional code reading apparatus that may be printed on any item including jewelry, clothing, shoes, and so on. The machine-readable symbol may include a graphic background and a two-dimensional matrix within which certain information has been encoded. In one embodiment, the geometric dots represent binary codes. Encoding information in a symbol is well known in the art and for brevity is not described further in this specification.

Furthermore, teachings of certain embodiments recognize the capability to use Quick Response (QR) codes/NFC, as a communication medium for transmitting personalized messages from a sender to an intended recipient to celebrate various types of occasions. A personalized message is a message created by a sender for delivery to an intended recipient in form of a tag which is inbuilt into any gift. The personalized message may be personalized for the intended recipient by including content based on the identity of the intended recipient. For example, a husband, Henry, may send personalized messages to his wife, Wilma, on her birthday. Example personalized messages in this scenario may include: “Happy Birthday,” “Happy Birthday, Wilma,” and “Happy Birthday to my loving wife.” Each of these example personalized messages includes content based on the identity of the intended recipient, Wilma, by referring to Wilma's birthday.

If Henry wants to send Wilma a gift (such as flowers or candy), certain embodiments may allow Henry to have a personalized message delivered with that gift. Henry may use a service, such as a service offered by the current method, where the message is stored in QR/NFC-enabled tag built-in gift and associates the personalized message to a QR code. By using a QR code/NFC tag rather than or in addition to a typical greeting card, Henry may send a personalized message containing media such as audio or video. For example, Henry may record himself saying “Happy Birthday Wilma” on video, and the QR code may include a link to this video. When Wilma receives the gift and scans the QR code/NFC tag on the card, Wilma may receive the personalized message by, for example, downloading a media file, or watching/listening/reading the message from her browser (e.g., via streaming) or within a smartphone application.

In the example of above, each entity includes a user and a computer system. Users may include any individual, group of individuals, and/or entity that interacts with the computer system. Examples of users include, but are not limited to, a sender and a recipient. A Package is a physical package to be delivered to the receiver. For example, a package may represent a gift that Henry wishes to send to his wife, Wilma. In the example, the package is delivered with a communication tag. A communication tag provides a mechanism for delivering a personalized message to the receiver. In one example embodiment, a communication tag is a two-dimensional barcode, such as a QR code. As described above, a QR code is a two-dimensional barcode that can be scanned by any of a variety of devices capable of optical recognition, such as purpose-built scanners, computers or smartphones connected to or comprising a camera. In situations in which the QR code is being scanned by a smartphone, the contents of the QR code may be interpreted by a mobile application running on the smartphone. In some scenarios, based on the content of the QR code, the device scanning the QR code can navigate to an URL embedded in the QR code to access content including but not limited to media files. The QR code may also directly download or present the media files without navigating to a URL. In some embodiments, the QR codes may be used to initiate contact (e.g., email, phone, text, instant message, etc.) with a company representative or to load an application provided by the company.

In another example embodiment, a communication tag is a near-field communication (NFC) device. NFC is a wireless technology that is used to exchange data between devices in very close proximity (2″ or less). Like QR codes, NFC may be capable of transmitting a personalized message. QR codes and NFC may both be used to augment retail transactions. This may be done by extending existing products or providing new products altogether. For example, a new type of product would be social expressions artifacts (greeting cards, wrapping paper, gift cards, gift card holders etc.) that include a pre-printed QR code that is customizable by an end user (e.g., the user who is purchasing the gift for another user). The purchasing user may be given the option to personalize such gifts through media files accessible through QR codes that are manufactured (printed) at very high standards (quality, consistency, artistic value, etc.) and included with the gift purchased by the purchasing user.

While a specific embodiment has been shown and described, many variations are possible. With time, additional features may be employed. The particular shape or configuration of the platform or the interior configuration may be changed to suit the system or equipment with which it is used. In the preferred embodiment of the invention the machine-readable symbol preferably is encoded with temporally permanent information about the decedent interred in the first interment space such as name, life history, text, messages related with particular items, videos, audios and pictures. The amount of encoded information may range from minimal to extensive. In one example, only the decedent's identity is coded into the symbol. In yet another example, a uniform resource locator, or URL for a remote database, may additionally be encoded in the machine-readable symbol.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A computer-implemented method for creating a digital platform storing, organizing, sharing, and transforming images, videos, documents, soundtracks, voice records, and useful links by a single scan of QR code/NFC/RFID wherein;
a machine-readable symbol physically associated with a first item which can range from any item of use like clothing, jewelry, shoes, toys and so on having the first set of information encoded therein;
a data repository storing a plurality of second sets of information associated with a plurality of articles; and
a portable device having a reader adapted to perceive and decode the machine-readable symbol from the first set of information, a transmitter adapted to send a first query based on the first set of information to the data repository by way of a communication network, a receiver adapted to receive one of the second sets of information from the data repository by way of the communication network, and a display adapted to present a first biography of the first article.

2. The system of claim 1 wherein the set of information includes textual, visual, and audio information.

3. The system of claim 1 wherein the portable device includes a back-end software able to decode the NFC tag/RFID and QR code.

4. The system of claim 1, wherein the machine-readable symbol can be printed, embossed or engraved on any item of use.

5. The method of claim 1, wherein the personalized message is a video message.

6. The method of claim 1, further comprising receiving a request to transmit the physical package with the personalized message to the intended recipient.

7. The method of claim 1, sending the QR code for inclusion with the physical package when the physical package is transmitted to the intended recipient.

8. The method of claim 1, wherein the personalized message is received from a sender, the method further comprises receiving, through the webpage, a personalized response message to the sender from the intended recipient in response to the personalized message.

9. The method of claim 1, further comprises the personalized message in form of text, pictures, audio, and video file.
